(19) United States
(12) Patent Application Publication
(10) Pub. No.: US 2020/0319589 A1
(43) Pub. Date: Oct. 8, 2020

(54) IMAGE FORMING APPARATUS

(71) Applicant: CANON KABUSHIKI KAISHA, Tokyo (JP)

(72) Inventors: Masafumi Takahashi, Tsukubamirai-shi (JP); Yuki Amauchi, Kawasaki-shi (JP)

(21) Appl. No.: 16/909,875

(22) Filed: Jun. 23, 2020

Related U.S. Application Data
(63) Continuation of application No. 16/289,460, filed on Feb. 28, 2019.
Application No. 16/289,460 is a continuation of application No. 15/473,296, filed on Mar. 29, 2017, now abandoned.

(30) Foreign Application Priority Data
Mar. 31, 2016 (JP) 2016-072787

(51) Int. Cl. G03G 21/20; G03G 15/08; G03G 21/16

(52) U.S. Cl. CPC G03G 21/206; G03G 15/0896; G03G 2221/1684; G03G 2221/1654; G03G 21/1623

(57) ABSTRACT

When a position of a developing unit with respect to a photoreceptor unit, the developing unit being mounted in an image forming apparatus, is switched to a contact position from a separation position with a switching unit, the developing unit at the contact position is brought to a state forming a predetermined space with the guide unit through which an airflow generated by a fan and that flows in a longitudinal direction of the guide unit flows, and when the position of the developing unit with respect to the photoreceptor unit, the developing unit being mounted in the image forming apparatus, is switched to the separation position from the contact position with the switching unit, the developing unit at the separation position is brought to a state in which the developing unit enters at least a portion of an area of the predetermined space.

### CROSS REFERENCE TO RELATED APPLICATION

The present application is a continuation of U.S. patent application Ser. No. 16/289,460, filed on Feb. 28, 2019, which is a continuation of U.S. patent application Ser. No. 15/473,296, filed on Mar. 29, 2017, which claims the benefit of Japanese Patent Application No. 2016-072787, filed Mar. 31, 2016, which are hereby incorporated by reference herein in their entirety.

### BACKGROUND

### Field of the Disclosure

The present disclosure relates to an image forming apparatus, such as a copier, a printer, or a facsimile, that includes a developing unit that is detachable from the image forming apparatus in an independent manner with respect to a photoreceptor unit.

### Description of the Related Art

In image forming apparatuses including photoreceptor units that have photosensitive drums serving as image carriers, and developing units that develop latent images formed on the photosensitive drums, there is one in which the developing units are each configured so as to be detachable from the image forming apparatus (see Japanese Patent Laid-Open No. 2012-159679). In the above image forming apparatus, attaching portions for attaching and detaching the developing units to and from the image forming apparatus are included on the image forming apparatus side. The developing units are attached and detached to and from the image forming apparatus by being slid along the attaching portions.

When the temperatures of the developing units increase due to the heat generated by the fixing unit and the like during the operation of the image forming apparatus such that the temperatures of the developers contained in the developing units increase, the fluidity of each developer becomes low. Accordingly, in the image forming apparatus in Japanese Patent Laid-Open No. 2012-159679, a cooling unit that cools the developing units are disposed below the developing units, and ducts for supplying air sent from a fan to the developing units are attached below the developing units. In the above image forming apparatus, the developing units are slid from a front side to a back side of the image forming apparatus along the attaching portions, and the developing units and the ducts are moved in an integral manner in a direction in which the developing units are inserted into the image forming apparatus.

In a configuration in which ducts are attached to developing units that are detachable from the image forming apparatus in an independent manner with respect to photoreceptor units, in addition to a space for moving the developing units in a direction in which the developing units are inserted into the image forming apparatus, a space for moving the duct in the above direction needs to be provided in advance inside the apparatus. Furthermore, in such a configuration, in order to move the developing units to contact positions, which is where the developing units are in contact with the photoreceptor units, a space in which the duct moves to the contact position needs to be provided in advance inside the image forming apparatus in addition to the space for the developing units to move to the contact positions. Furthermore, in a similar manner, in the above configuration, in order to move the developing units to separation positions, which is where the developing units are separated from the photoreceptor units, a space in which the duct moves to the separation position needs to be provided in advance inside the image forming apparatus in addition to the space for the developing units to move to the separation positions.

On the other hand, if a space for separating the developing unit, which is detachable from the image forming apparatus in an independent manner with respect to the photoreceptor unit, from the photoreceptor unit, and a space for the flow of air from the fan cooling the developing units to pass are separately provided inside the image forming apparatus in advance, the size of the apparatus becomes disadvantageously large.

### SUMMARY

The present disclosure provides, while avoiding increase in size, an apparatus that is capable of forming an airflow generated by a fan that cools developing units. The present disclosure relates to an image forming apparatus that forms an image on a recording medium, the image forming apparatus comprising: a photoreceptor unit including a photoreceptor on which an electrostatic latent image is formed; a developing unit that develops an electrostatic latent image formed on the photoreceptor, the developing unit being detachable from the image forming apparatus in an independent manner with respect to the photoreceptor unit; a guide unit that guides the developing unit in a mounting direction when mounting the developing unit in the image forming apparatus, and that guides the developing unit in an unmounting direction when unmounting the developing unit from the image forming apparatus; a switching unit that switches a position of the developing unit with respect to the photoreceptor unit, the developing unit being guided by the guide unit and being mounted in the image forming apparatus, between a contact position in which the developing unit and the photoreceptor unit are in contact with each other to form an image, and a separation position in which the developing unit is separated from the photoreceptor unit; and a fan that generates an airflow that cools the developing unit, wherein when the position of the developing unit with respect to the photoreceptor unit, the developing unit being mounted in the image forming apparatus, is switched to the contact position from the separation position with the switching unit, the developing unit at the contact position is brought to a state forming a predetermined space with the guide unit through which the airflow that is generated by the fan and that flows in a longitudinal direction of the guide unit flows, and wherein when the position of the developing unit with respect to the photoreceptor unit, the developing unit being mounted in the image forming apparatus, is switched to the separation position from the contact position with the switching unit, the developing unit at the separation position is brought to a state in which the developing unit enters at least a portion of an area of the predetermined space. The present disclosure further relates to an image forming apparatus that forms an image on a recording medium, the image forming apparatus comprising: a photoreceptor unit including a photoreceptor on which an electrostatic latent image is formed; a developing unit that develops an electrostatic latent image formed on the photoreceptor, the developing unit being detachable from the image forming apparatus in an independent manner with respect to the photoreceptor unit; a guide unit that guides the developing unit in a mounting direction when mounting the developing unit in the image forming apparatus, and that guides the developing unit in an unmounting direction when unmounting the developing unit from the image forming apparatus; a switching unit that switches a position of the developing unit with respect to the photoreceptor unit, the developing unit being guided by the guide unit and being mounted in the image forming apparatus, between a contact position in which the developing unit and the photoreceptor unit are in contact with each other to form an image, and a separation position in which the developing unit is separated from the photoreceptor unit; and a fan that generates an airflow that cools the developing unit, wherein when the position of the developing unit with respect to the photoreceptor unit, the developing unit being mounted in the image forming apparatus, is switched to the contact position from the separation position with the switching unit, the developing unit at the contact position is brought to a state forming a predetermined space with the guide unit through which the airflow that is generated by the fan flows, wherein when the position of the developing unit with respect to the photoreceptor unit, the developing unit being mounted in the image forming apparatus, is switched to the separation position from the contact position with the switching unit, the developing unit at the separation position is brought to a state in which the developing unit enters at least a portion of an area of the predetermined space, and wherein by moving the developing unit mounted in the image forming apparatus vertically upwards in a sliding manner, the switching unit switches the position of the developing unit with respect to the photoreceptor unit, the developing unit being mounted in the image forming apparatus, to the contact position from the separation position, and by moving the developing unit mounted in the image forming apparatus vertically downwards in a sliding manner, the switching unit switches the position of the developing unit with respect to the photoreceptor unit, the developing unit being mounted in the image forming apparatus, to the separation position from the contact position.

Further features of the present disclosure will become apparent from the following description of exemplary embodiments with reference to the attached drawings.

### BRIEF DESCRIPTION OF THE DRAWINGS

FIG. 1 is a perspective view illustrating an overall configuration of an image forming apparatus according to a first exemplary embodiment.

FIG. 2 is a perspective view illustrating an overall configuration of the image forming apparatus according to the first exemplary embodiment.

FIG. 3 is a cross-sectional view illustrating an inside configuration of the image forming apparatus according to the first exemplary embodiment.

FIG. 4 is a perspective view illustrating a configuration of a process unit according to the first exemplary embodiment.

FIG. 5 is a perspective view illustrating a configuration of the process unit according to the first exemplary embodiment.

FIG. 6 is a perspective view illustrating an overall configuration of a developing unit according to the first exemplary embodiment.

FIG. 7 is a perspective view illustrating an overall configuration of a developing unit according to the first exemplary embodiment.

FIG. 8 is a perspective view illustrating a configuration of a guide unit according to the first exemplary embodiment.

FIGS. 9A and 9B are schematic diagrams illustrating a configuration of a separating mechanism of the developing unit according to the first exemplary embodiment.

FIGS. 10A and 10B are cross-sectional views illustrating a configuration of the separating mechanism of the developing unit according to the first exemplary embodiment.

FIG. 11 is a perspective view illustrating a configuration of a cooling mechanism of the developing unit according to the first exemplary embodiment.

FIG. 12 is a cross-sectional view illustrating the configuration of the cooling mechanism of the developing unit according to the first exemplary embodiment.

FIG. 13 is a perspective view illustrating a configuration of a guide unit according to a second exemplary embodiment.

FIGS. 14A and 14B are cross-sectional views illustrating a configuration of a separating mechanism of the developing unit according to the second exemplary embodiment.

FIG. 15 is a perspective view illustrating a configuration of a guide unit according to a third exemplary embodiment.

FIGS. 16A and 16B are schematic diagrams illustrating a configuration of a separating mechanism of the developing unit according to the third exemplary embodiment.

FIGS. 17A and 17B are cross-sectional views illustrating a configuration of a pressing mechanism of a developing unit according to a fourth exemplary embodiment.

FIGS. 18A and 18B are cross-sectional views illustrating a configuration of a separating mechanism of the developing unit according to the fourth exemplary embodiment.

### DESCRIPTION OF THE EMBODIMENTS

### Description of the Preferred Embodiments

Hereinafter, exemplary embodiments of the present disclosure will be described in detail with reference to the accompanying drawings. Note that the exemplary embodiments described hereinafter do not limit the present disclosure according to the Claims, and the combinations of the features described in the exemplary embodiments are not necessarily essential in the solution of the present exemplary embodiment. The present disclosure can be embodied in various applications, such as a printer, various printing machines, a copier, a fax machine, and a multifunction apparatus.

### First Exemplary Embodiment

### Configuration of Image Forming Apparatus

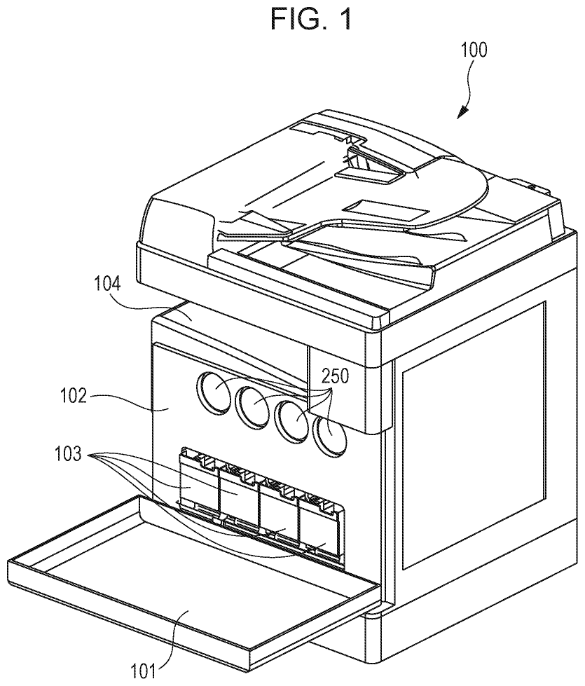

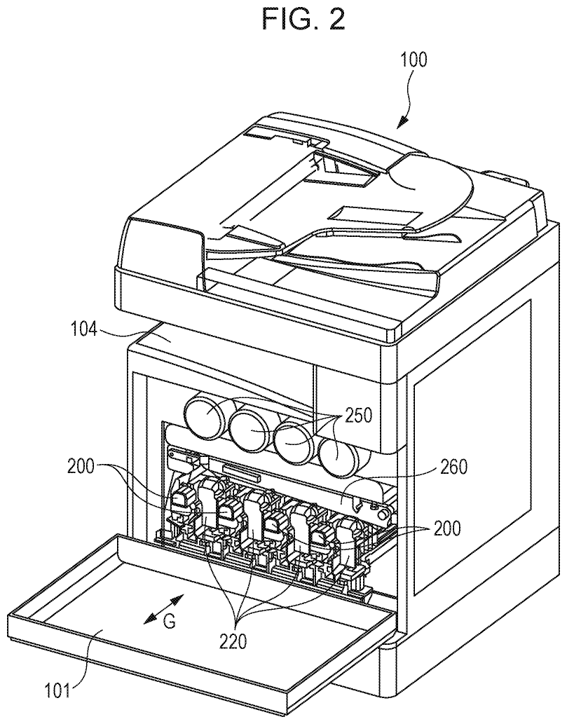

An overall configuration of an image forming apparatus according to a first exemplary embodiment of the present disclosure will be described first with reference to the perspective views in FIGS. 1 and 2. FIG. 1 is a diagram illustrating an overall image of an image forming apparatus 100 in which a front cover 101 is open to a front side of the image forming apparatus 100. FIG. 2 is a diagram in which an inner cover 102, small covers 103, and a portion of a frame have been made transparent while the front cover 101 is open to the front side of the image forming apparatus 100. FIG. 2 illustrates an arrangement of units, such as photoreceptor units 220 including photosensitive drums that are image carriers, and developing units 200 that develop latent images formed on the photosensitive drums.

As illustrated in FIG. 1, the image forming apparatus 100 includes the front cover 101 that is a cover for accessing each of the units of the image forming apparatus 100. As illustrated in FIG. 1, the image forming apparatus 100 further includes the inner cover 102 that is a cover for accessing toner cartridges 250, and the small covers 103 that are covers for accessing the developing unit 200 and the photoreceptor units 220.

The developing units 200 according to the first exemplary embodiment can be detached from the image forming apparatus 100 in an independent manner with respect to the photoreceptor units 220. Furthermore, each of the developing units 200 and the photoreceptor units 220 can be replaced independently according to the life of each of the developing units 200 and the photoreceptor units 220. Accordingly, a user such as an operator or a service technician first opens the front cover 101 towards the front side of the image forming apparatus 100 when attaching and detaching or replacing the developing units 200 and the photoreceptor units 220. Subsequently, the user further opens the small covers 103 while the cover 101 is open towards the front side of the image forming apparatus 100. With the above, since the developing units 200 and the photoreceptor units 220 become exposed, the developing units 200 and the photoreceptor units 220 can be attached and detached or replaced. In the above state, the user inserts or removes the developing units 200 and the photoreceptor units 220 in a G-direction in FIG. 2.

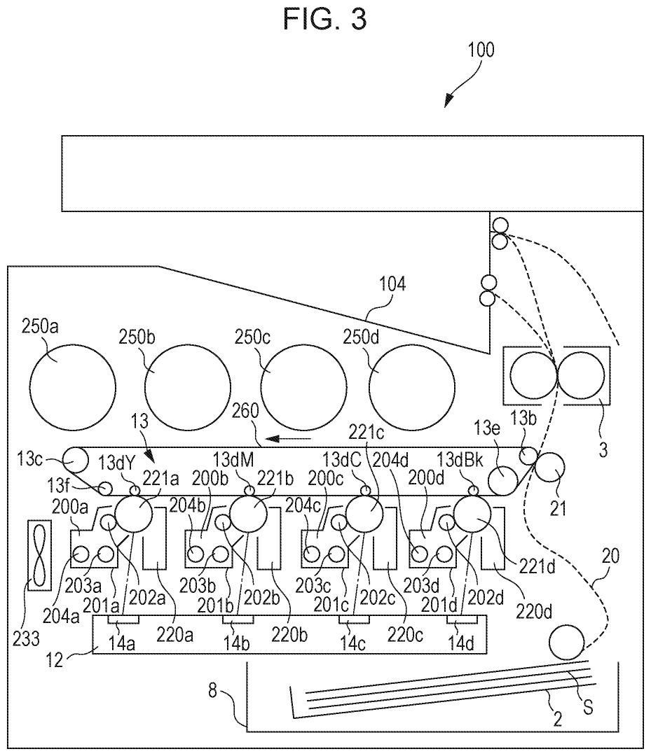

As illustrated in FIG. 2, the image forming apparatus 100 includes the developing units 200, the photoreceptor units 220, and an intermediate transfer belt (ITB) 260 that is an image carrier. Furthermore, the image forming apparatus 100 includes the toner cartridges 250 that supply toner of various colors, such as yellow (Y), magenta (M), cyan (C), and black (Bk) to the developing units 200. Furthermore, the image forming apparatus 100 includes a discharge tray 104 for discharging a recording medium on which an image is formed (printed) with the image forming apparatus 100. Details of the developing units 200, the photoreceptor units 220, the intermediate transfer belt 260, the toner cartridges 250, and the discharge tray 104 will be described later in FIG. 3.

An inner configuration of the image forming apparatus 100 will be described next with reference to a cross-sectional view in FIG. 3. FIG. 3 is a diagram illustrating an arrangement of an image forming unit inside the image forming apparatus 100.

As illustrated in FIG. 3, the image forming apparatus 100 is a full color printer employing a tandem intermediate transfer system in which image forming units of various colors such as yellow (Y), magenta (M), cyan (C), and black (Bk) are disposed along the intermediate transfer belt (ITB) 260. The photoreceptor units 220 (220a to 220d) that include the photosensitive drums 221 (221a to 221d) and charging rollers that charges the photosensitive drums 221 (221a to 221d) are disposed inside the image forming apparatus 100. Four process units including the developing units 200 (200a to 200d) that develop the latent image formed on the photosensitive drums 221 (221a to 221d) are further included inside the image forming apparatus 100. The process units are used to form yellow (Y), magenta (M), cyan (C), and black (Bk) images.

The image forming apparatus 100 includes, below the process units, a laser unit 12 that constitutes an exposure unit. When image signals of yellow (Y), magenta (M), cyan (C), and black (Bk) are input, the laser unit 12 emits laser beams onto the surfaces of the photosensitive drums 221 (221a to 221d) according to the image signals. The laser beams emitted by the laser unit 12 transmit through exposure windows 14 (14a to 14d) and is projected onto the photosensitive drums 221 (221a to 221d). Subsequently, the charge on each of the photosensitive drums 221 (221a to 221d) are neutralized and electrostatic latent images are formed.

Toner supply units that deliver toner supplied from the toner cartridges 250 (250a to 250d) to the developing units 200 (200a to 200d) are disposed on a back side of the image forming apparatus 100.

The developing units 200 (200a to 200d) include developer containers 201 that accommodates the developer. In the first exemplary embodiment, a two-component developer that includes nonmagnetic toner and a magnetic carrier developer is described as an example of the developer; however, the developer is not limited to the above. The developer may be a mono-component developer formed of magnetic toner.

The developing units 200 (200a to 200d) include developing sleeves 202 (202a to 202d) serving as developer carrying members. As illustrated in FIG. 3, the developing sleeves 202 (202a to 202d) are disposed at positions opposing the photosensitive drums 221 (221a to 222d).

The intermediate transfer belt 260 is stretched (supported) by various types of rollers, such as an idler roller 13e, a secondarily transferring inner roller 13b, a tension roller 13c, a conveying roller 13f, and primary transfer rollers 13dY, 13dM, 13dC, and 13dBk. As illustrated in FIG. 3, the secondarily transferring inner roller 13b is disposed along a conveyance path of a recording medium S. The recording medium S includes sheets, such as plain paper, recycled paper, and thick paper on which an image is formed with the image forming apparatus 100, and films such as an OHP film. Furthermore, a secondarily transferring outer roller 21 is disposed at a position opposing the secondarily transferring inner roller 13b. Furthermore, a secondary transfer nip portion is formed between the secondarily transferring inner roller 13b and the secondarily transferring outer roller 21.

The image forming apparatus 100 includes the photosensitive drums 221 (221a to 221d) that are each provided with a charging roller for charging the corresponding one of the photosensitive drums 221 (221a to 221d). The image forming apparatus 100 further includes a sheet cassette 8 including a stacking portion 2 on which the recording medium S is stacked. Furthermore, the image forming apparatus 100 includes a conveyance path 20 through which the recording medium S is conveyed. The image forming apparatus 100 further includes a fixing unit 3 that compresses and heats the toner images transferred to the recording medium S and that fixes the toner image to the recording medium S. The image forming apparatus 100 further includes the discharge tray 104 that discharges the recording medium S to which the toner images have been fixed with the fixing unit 3.

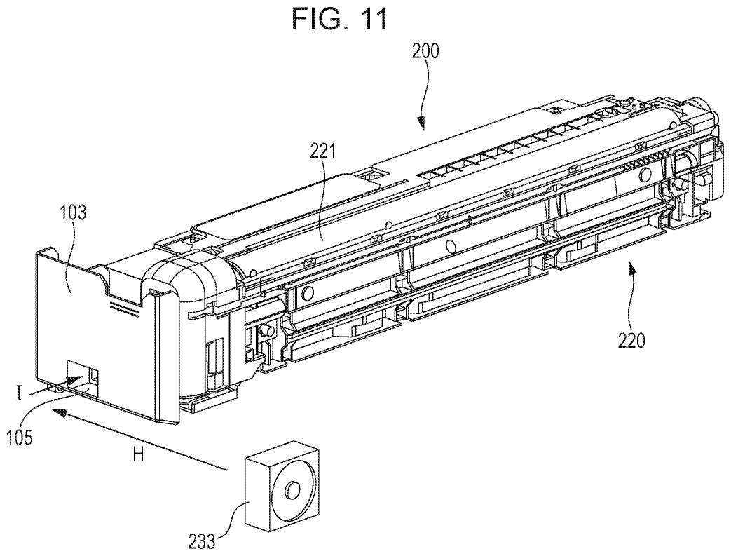

Furthermore, the image forming apparatus 100 includes a fan 233 that cools the developing units 200 (200a to 200d). Details of the fan 233 will be described later in FIG. 11.

### Image Forming Operation

The image forming apparatus 100 separates and sends out the recording mediums S stacked on the stacking portion 2 sheet by sheet with a roller. The recording medium S fed from the sheet cassette 8 is conveyed along the conveyance path 20 and reaches the secondary transfer nip portion formed between the secondarily transferring inner roller 13band the secondarily transferring outer roller 21.

The latent images formed on the surfaces of the photosensitive drums 221 (221a to 221d) with the laser unit 12 are developed as toner images with the developing units 200 (200a to 200d). Furthermore, the toner images developed with the developing units 200 (200a to 200d) are primarily transferred onto the intermediate transfer belt 260 with the primary transfer rollers (13dY, 13dM, 13dC, and 13dK).

In the first exemplary embodiment, the image forming apparatus 100 includes the plurality of photoreceptor units 220 (220a to 220d). Accordingly, in the first exemplary embodiment, a color toner image formed by sequentially overlaying the toner images developed in various colors, namely, yellow (Y), magenta (M), cyan (C), and black (Bk), onto the intermediate transfer belt 260 is secondarily transferred onto the recording medium S.

Note that the image forming process according to the first exemplary embodiment will be described with the yellow (Y) color among the yellow (Y), magenta (M), cyan (C), and black (Bk) colors. The yellow toner is supplied to the developing unit 200a from the toner cartridge 250a, first. Subsequently, the toner image (the yellow toner image) that has been developed by the yellow toner supplied to the developing unit 200a is formed on the photosensitive drum 221a. Subsequently, the yellow toner image formed on the photosensitive drum 221a is transferred onto the intermediate transfer belt 260. The magenta toner image is formed on the photosensitive drum 221b with a similar process. Subsequently, the magenta toner image is transferred so as to be overlaid on the yellow toner image on the intermediate transfer belt 260. Furthermore, the cyan toner image and the black toner image are formed and are sequentially transferred onto the intermediate transfer belt 260 with a similar process.

The color toner image formed on the intermediate transfer belt 260 reaches the secondary transfer nip portion formed between the secondarily transferring inner roller 13b and the secondarily transferring outer roller 21 and is secondarily transferred onto the surface of the recording medium S. Subsequently, the recording medium S on which the color toner image has been secondarily transferred is separated from the intermediate transfer belt 260 and is conveyed to the fixing unit 3. Subsequently, the recording medium S is conveyed to a fixing nip portion formed between a heating roller and a pressing roller of the fixing unit 3 and is heated and compressed with the fixing nip portion such that the toner image is fixed to the surface of the recording medium S. Subsequently, the recording medium S on which the toner image has been fixed with the fixing unit 3 is conveyed to the discharge tray 104 and is discharged to the discharge tray 104.

### Configuration of Process Unit

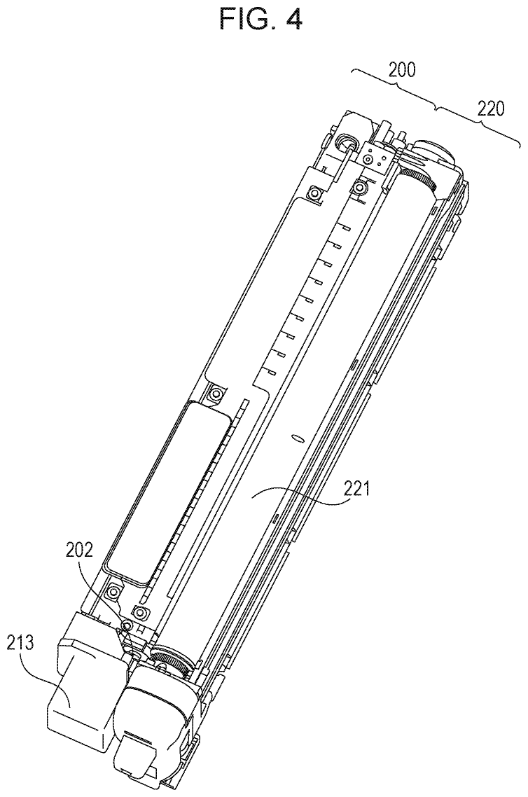

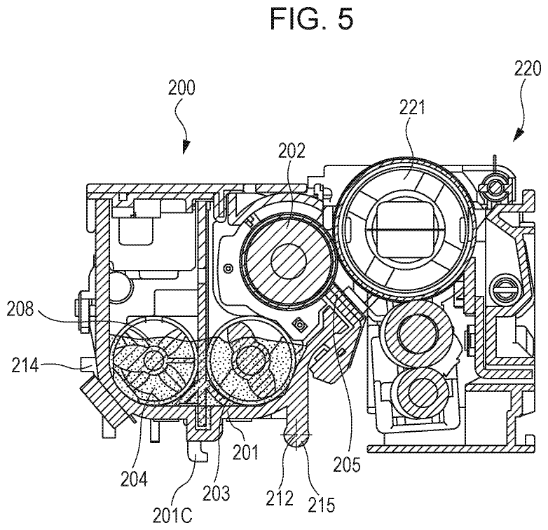

A configuration of the process unit including the developing unit 200 and the photoreceptor unit 220 will be described next with reference to a perspective view in FIG. 4 and a cross-sectional view in FIG. 5.

The developing sleeve 202 and the photosensitive drum 221 are disposed inside the image forming apparatus 100 so as to be adjacent to each other at a predetermined distance. When a minute gap (hereinafter, referred to as an SD gap) between the developing sleeve 202 and the photosensitive drum 221 changes, a poor image, such as an image with uneven density, is created. Accordingly, a bearing is rotatably provided at both ends of each of the photosensitive drum 221 and the developing sleeve 202 so that the SD gap is kept uniform. Furthermore, a developing blade 205 that restricts the coating of the toner on the developing sleeve 202 to a uniform amount is provided inside the developing unit 200. A front cover 213 is attached to the developing unit 200. The developing unit 200 is mounted in a main body of the image forming apparatus 100 with the front cover 213 attached to the developing unit 200.

As illustrated in FIG. 5, the developing unit 200 is filled with the developer up to the position of a developer surface 208. The developer is circulated inside the developer container 201 with conveying screws 203 and 204 and is conveyed to the developing sleeve 202. The conveying screws 203 and 204 have, for example, shapes formed with a spiral blade about the rotating shaft of the conveying screws 203 and 204.

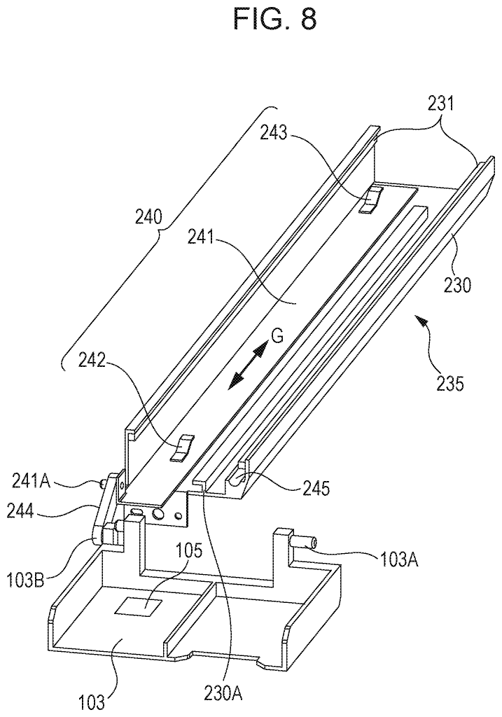

Furthermore, as illustrated in FIG. 5, a rotation restriction rib 201C that engages with a rotation restriction rib 230A on a developer tray 230 side described later in FIG. 8 is provided in the developer container 201. A rib 214 that is in pressure contact with a sealing member 231 on the developer tray 230 side, and a rib 215 that engages with a groove portion 245 on the developer tray 230 side are further provided in the developer container 201. The developer tray 230 is a tray that guides the developing unit 200 in a direction in which the developing unit 200 is mounted on the main body of the image forming apparatus 100. The developing unit 200 is capable of being pivoted about a rotation axis 212 that is parallel to a rotational axis of the developing sleeve 202. Note that FIG. 5 illustrates a state in which the developing unit 200 is pivoted about the rotation axis 212 to a predetermined pressing position. Configuration of developing unit

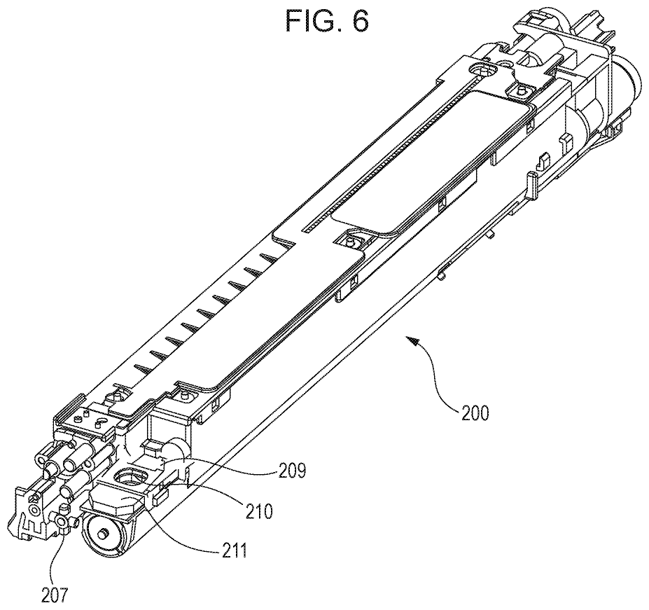

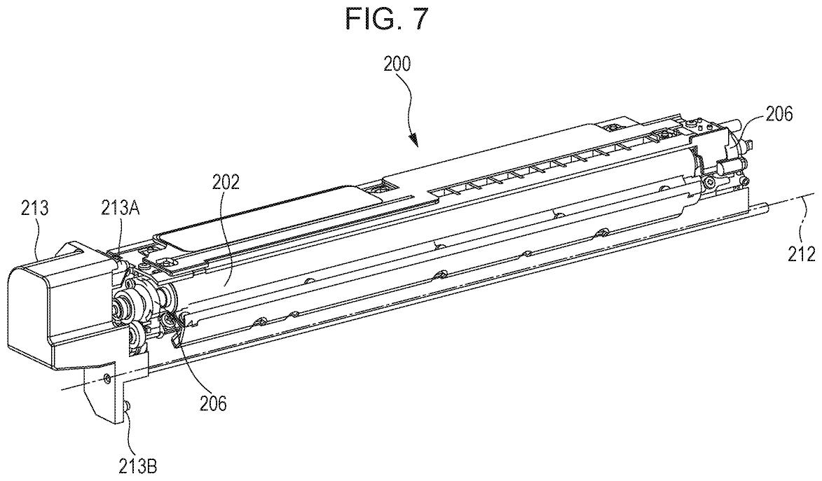

An overall configuration of the developing unit 200 will be described next with reference to the perspective views in FIGS. 6 and 7.

As illustrated in FIG. 6, the developing unit 200 includes a supply port 209 through which toner is supplied, a supply shutter 210 that closes the opening of the supply port 209, and a sealing member 211. The supply port 209 is disposed above the conveying screw 204 and is connected to the toner supply unit.

In the image forming apparatus 100, each of the developing units 200 and the photoreceptor units 220 can be replaced independently according to the life of each of the developing units 200 and the photoreceptor units 220. When the developing unit 200 is attached and detached from the main body of the image forming apparatus 100, the supply shutter 210 closes the opening of the supply port 209 and seals therein the developer inside the developing unit 200.

As described above, a bearing is rotatably provided at both ends of the photosensitive drum 221 so that the SD gap is kept uniform. Furthermore, a bearing 206 is rotatably provided at both ends of the developing sleeve 202. With the above, the developing sleeve 202 and the photosensitive drum 221 are disposed so as to be adjacent to each other at a predetermined distance. In so doing, the developing unit 200 is at a contact position that is in contact with the photosensitive drum 221. Accordingly, when the developing unit 200 is attached and detached from the main body of the image forming apparatus 100, if the developing unit 200 is inserted into and removed from the front side of the image forming apparatus 100 without moving the developing unit 200 to a separation position, scratches may be formed on the photosensitive drum 221 and the developing sleeve 202.

In the first exemplary embodiment, when attaching and detaching the developing unit 200 from the main body of the image forming apparatus 100, the developing unit 200 is moved to the separation position so that the developing unit 200 and the photoreceptor unit 220 do not slide against each other. The separation position is a position where the developing unit 200 is separated from the photoreceptor unit 220 at a sufficient distance. As illustrated in FIG. 7, the developing unit 200 is pivoted about the rotation axis 212 that is parallel to the developing sleeve 202 when the developing unit 200 is moved to the separation position. The position of the rotation axis 212 is determined by the main body of the image forming apparatus 100 and the front cover 213. Furthermore, the position of the front cover 213 is determined by positioning pins 213A and 213B. With the above, the developing unit 200 is set to a position rotatable about the rotation axis 212.

Furthermore, as illustrated in FIG. 6, the developing unit 200 includes a drive coupling 207 that drives the developing sleeve 202 and the conveying screws 203 and 204. The drive coupling 207 receiving an input of a drive from the drive force inside the image forming apparatus 100 rotationally drives the developing sleeve 202 and the conveying screws 203 and 204. Upon rotational drive of the developing sleeves 202 and the conveying screws 203 and 204, the developer contained in the developing unit 200 is mixed and the developer circulates inside the developer container 201.

In the two-component developer, iron is included in the composition of the developer. Accordingly, the drive energy generated by mixing the developer with the conveying screws 203 and 204 is converted into heat in the developer generated by the developer itself. As the agitation speed and the circulation velocity of the developer become larger, the heat quantity added to the developer becomes larger, and the heat quantity accumulated in the developer becomes larger. Furthermore, upon operation of the image forming apparatus 100, the developing units 200, the photoreceptor units 220, the exposure unit, the transfer unit, and the fixing unit 3 are driven and heat is generated. Note that the exposure unit is constituted by the laser unit 12 and the like, and the transfer unit is constituted by the intermediate transfer belt 260 and the like. Furthermore, upon operation of the image forming apparatus 100, the temperature of the fixing unit 3 increases and heat is generated from the fixing unit 3. The developer is vulnerable to heat, and by continuously applying heat to the developer, the fluidity of the developer becomes lower. When the fluidity of the developer becomes low, the quality characteristic of the developer becomes poor creating, for example, a change in the coating amount of the developer on the developing sleeves 202, a change in electric polarity, and damage in the developer. As a result, a decrease in image quality, such as uneven density in the image formed by the image forming apparatus 100 and low density of the image formed by the image forming apparatus 100, occurs.

In recent years, an increase in the process speed of the image forming apparatus 100 and miniaturization of the main body of the image forming apparatus 100 are both required. When the process speed of the image forming apparatus 100 is increased, the speed in which various units, such as the developing units 200, the photoreceptor units 220, the exposure unit, the transfer unit, and the fixing unit 3 are driven and the speed in which the temperature of the fixing unit 3 increases increase. Accordingly, as the process speed of the image forming apparatus 100 is increased, the heat quantity per unit time generated inside the image forming apparatus 100 becomes larger. Meanwhile, in a case in which the main body of the image forming apparatus 100 is reduced in size, the space for releasing the heat generated inside the image forming apparatus 100 becomes small. Accordingly, in a case in which the increase in the process speed of the image forming apparatus 100 and the reduction in the size of the main body of the image forming apparatus 100 are both achieved, the increase in the temperature inside the image forming apparatus 100 becomes noticeable as the image forming apparatus 100 is operated. When the increase in temperature inside the image forming apparatus 100 becomes noticeable, the heat quantity added to the developer included in the developing units 200 becomes large.

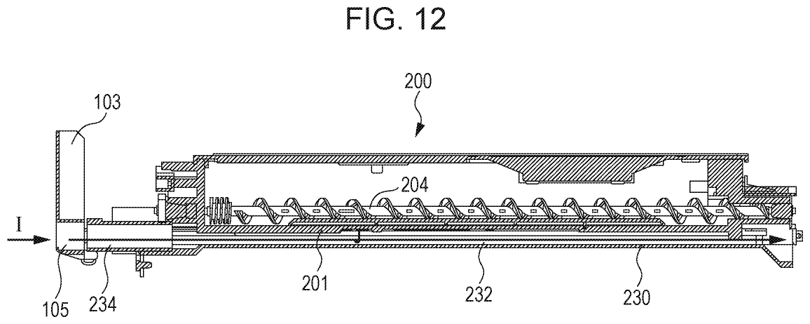

Accordingly, in the first exemplary embodiment, in order to suppress the increase in temperature of the developer inside the developing units 200, bottom surfaces of the developer containers 201 that have the largest area in contact with the developer are cooled. A configuration of the cooling mechanisms of the developing units 200 will be described later with reference to FIGS. 11 and 12. Configuration of guide unit

A configuration of a guide unit including the developer tray that guides the developing unit 200 in the direction in which the developing unit 200 is inserted into the image forming apparatus 100 will be described with reference to the perspective view in FIG. 8.

As illustrated in FIG. 8, a guide unit 235 according to the first exemplary embodiment includes the developer tray 230, the sealing member 231, the groove portion 245 that engages with the rib 215 of the developer container 201, the rotation restriction rib 230A that engages with the rotation restriction rib 201C of the developer container 201. Note that the sealing member 231 is formed of a sealing member, such as a sponge.

Furthermore, a pressure unit 240 capable of moving in the G-direction in FIG. 8 is provided in the guide unit 235. The position of the guide unit 235 is set by the main body of the image forming apparatus 100, and the guide unit 235 is fixed inside the image forming apparatus 100.

The pressure unit 240 includes a pressure link 241 and pressure members 242 and 243. In the first exemplary embodiment, the pressure members 242 and 243 are members that are capable of being elastically deformed, such as flat springs. Note that the pressure members 242 and 243 may each be any member configured to press the developing unit 200, and may be an elastic member such as a spring that holds a pressure piece in a swingable manner.

The small cover 103 is connected to a pivot link 244 connected to the pressure link 241 with a link shaft 103B. The small cover 103 is pivotal about the rotating shaft 103A. Furthermore, an opening 105 is provided in each small cover 103. The air sent in with the fan 233 passes through each opening 105 and is sent into each developing unit 200.

The developer tray 230 is capable of sliding the developing unit 100 in the G-direction in FIG. 8. The developer tray 230 serves as a guide that guides the developing unit 200 in the G-direction in FIG. 8 so that the insertion and removal of the developing unit 200 can be performed while the developing unit 200 is separated from the photoreceptor unit 220.

When mounting the developing unit 200 in the main body of the image forming apparatus 100, the user first opens the front cover 101 towards the front side of the image forming apparatus 100 and, subsequently, opens the small cover 103 towards the front side of the image forming apparatus 100. Subsequently, while in a state in which the rib 215 of the developer container 201 is engaged with the groove portion 245, the user slides the developing unit 200 in the direction (hereinafter, referred to as a mounting direction) in which the developing unit 200 is mounted in the main body of the image forming apparatus 100.

Subsequently, the user closes the small cover 103 after the developing unit 200 is mounted in the main body of the image forming apparatus 100. In so doing, by rotating the small cover 103 clockwise (in a circumferential direction) about the rotating shaft 103A, the developing unit 200 is relatively moved with respect to the guide unit 235. Then, the developing unit 200 is pressed by the pressure unit 240 and is pivoted about the rotation axis 212 to a development position (hereinafter, also referred to as a predetermined pressing position) where the latent image formed on the photosensitive drum 221 can be developed. Note that the development position is also a contact position where the developing unit 200 comes in contact with the photosensitive drum 221. When the developing unit 200 is pivoted to the predetermined pressing position, the rotation restriction rib 201C disposed on the developer container 201 side and the rotation restriction rib 230A provided in the developer tray 230 engage with each other such that the pivoting of the developing unit 200 is restricted. Subsequently, the user closes the front cover 101 after the developing unit 200 has been pivoted to the predetermined pressing position and the pivoting of the developing unit 200 has been restricted.

On the other hand, when dismounting the developing unit 200 from the main body of the image forming apparatus 100, the user first opens the front cover 101 towards the front side of the image forming apparatus 100 and, subsequently, opens the small cover 103 towards the front side of the image forming apparatus 100. In so doing, by rotating the small cover 103 anticlockwise (in the circumferential direction) about the rotating shaft 103A, the developing unit 200 is relatively moved with respect to the guide unit 235. Then, the applied pressure of the pressure unit 240 to the developing unit 200 is released, and the developing unit 200 is pivoted about the rotation axis 212 to the separation position (hereinafter, also referred to as a predetermined separation position) where the developing unit 200 is at a predetermined distance away from the photosensitive drum 221. Note that the predetermined separation position is a position where both the developing unit 200 and the photoreceptor unit 220 do not slide when the developing unit 200 is taken out from the main body of the image forming apparatus 100 by sliding the developing unit 200 in a direction (hereinafter, also referred to as an unmounting direction) opposite to the mounting direction.

When the developing unit 200 is pivoted to the predetermined separation position, the engagement between the rotation restriction rib 201C disposed on the developer container 201 side and the rotation restriction rib 230A provided in the developer tray 230 is canceled. In the above state, the rib 215 of the developer container 201 is engaged with the groove portion 245, and the developing unit 200 is slidable in the unmounting direction. After taking out the developing unit 200 from the main body of the image forming apparatus 100 by sliding the developing unit 200 in the unmounting direction, the user closes the small cover 103 and, subsequently, closes the front cover 101. The position of the developing unit 200, which is mounted in the main body of the image forming apparatus 100, with respect to the photoreceptor unit 220 can be switched in the above manner between the contact position in which the developing unit 200 is in contact with the photosensitive drum 221, and the separation position in which the developing unit 200 is separated from the photosensitive drum 221. Separating mechanism of developing unit

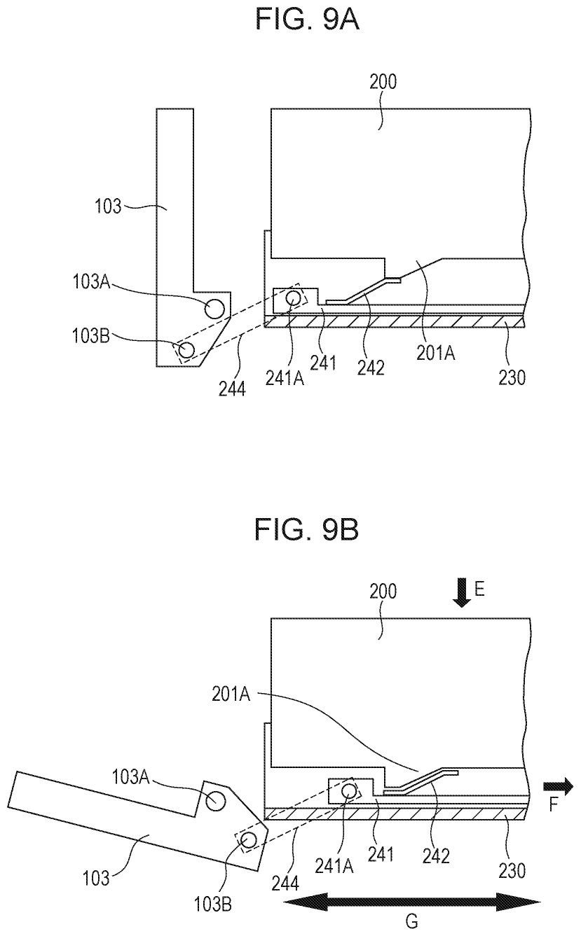

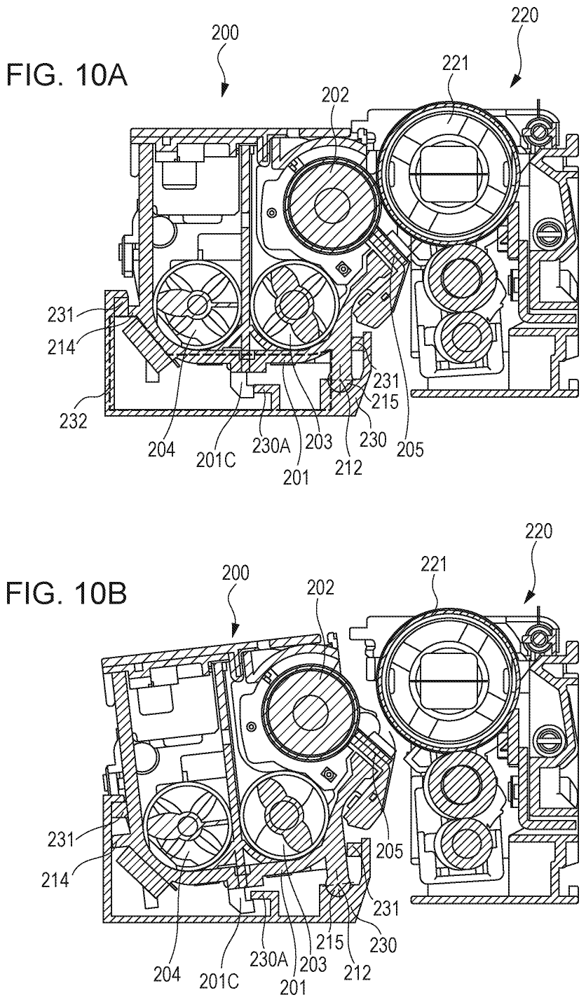

A separating mechanism of the developing unit 200 will be described next with reference to schematic diagrams in FIGS. 9A and 9B and cross-sectional views in FIGS. 10A and 10B. The units constituting the separating mechanism of the developing unit 200 serves as a switching unit that switches the position of the developing unit 200, which is mounted in the main body of the image forming apparatus 100, with respect to the photoreceptor unit 220 between the contact position and the separation position.

FIG. 9A illustrates the developing unit 200 in a pressed state in which the pressure member 242 on the front side of the developer tray 230 and a pressure portion 201A on the front side of the developer container 201 are abutted against each other. FIG. 9B illustrates the developing unit 200 in a separated state in which the abutment of the pressure member 242 and the pressure portion 201A has been cancelled.

As illustrated in FIGS. 9A and 9B, an inclined surface is formed in the pressure portion 201A on the front side of the developer container 201. Furthermore, an inclined surface is also formed in a similar manner in the pressure portion on a back side of the developer container 201. The above is to prevent interference between the pressure member 242 on the front side of the developer tray 230 and the pressure portion 201A on the front side of the developer container 201 when inserting and removing the developing unit 200 in the G-direction in FIG. 9B. In a similar manner, the above is to prevent interference between the pressure member 243 on the back side of the developer tray 230 and the pressure portion on the back side of the developer container 201 when inserting and removing the developing unit 200 in the G-direction in FIG. 9B.

When the small cover 103 is rotated in the anticlockwise direction about the rotating shaft 103A while the developing unit 200 is in a pressed state (a state in which the developing unit 200 is inserted inside the image forming apparatus 100 with the guide unit 235 and is at the predetermined pressing position) illustrated in FIG. 9A, the link shaft 103B is turned. Note that as illustrated in FIG. 9A, the link shaft 103B is vertically below the rotating shaft 103A. Accordingly, upon turning of the link shaft 103B, the pressure link 241 is pushed inwards in an F-direction in FIG. 9B with the pivot link 244 in between. When the pressure link 241 is pushed inwards in the F-direction in FIG. 9B, the pressure portion 201A slides down an inclined surface formed in the pressure member 242. With the above, since the developing unit 200 is moved in an E-direction in FIG. 9B, the developing unit 200 is separated from the photoreceptor unit 220. Note that the guide unit 235 is configured such that the position of the guide unit 235 is fixed and does not move with respect to the image forming apparatus 100 at least while the developing unit 200 is being separated from the photoreceptor unit 220.

On the other hand, when the small cover 103 is rotated clockwise about the rotating shaft 103A while the developing unit 200 is in a separated state (a state in which the developing unit 200 is inserted inside the image forming apparatus 100 with the guide unit 235 and is at the predetermined separation position) illustrated in FIG. 9B, the link shaft 103B is turned. Furthermore, upon turning of the link shaft 103B, the pressure link 241 is drawn outwards in a direction opposite the F-direction in FIG. 9B with the pivot link 244 in between. When the pressure link 241 is drawn outwards in a direction opposite the F-direction in FIG. 9B, the inclined surface formed in the pressure portion 201A on the front side of the developer container 201 and the pressure member 242 comes into contact with each other, and the inclined surface formed in the pressure portion on the back side of the developer container 201 and the pressure member 243 comes into contact with each other. With the above, the developing unit 200 is pressed by the pressure members 242 and 243 and is pivoted about the rotation axis 212 to the development position (the predetermined pressing position) where the latent image formed on the photosensitive drum 221 can be developed.

FIG. 10A illustrates the developing unit 200 that has been pivoted to the predetermined pressing position. FIG. 10B illustrates the developing unit 200 that has been pivoted to the predetermined separation position.

As illustrated in FIG. 10A, upon pivoting of the developing unit 200 about the rotation axis 212 to the predetermined pressing position, the rotation restriction rib 201C on the developer container 201 side and the rotation restriction rib 230A on the developer tray 230 side become engaged with each other. In other words, upon pivoting of the developing unit 200 about the rotation axis 212 to the predetermined pressing position, the main body of the image forming apparatus 100 and the developer container 201 become engaged with each other. Furthermore, upon pivoting of the developing unit 200 about the rotation axis 212 to the predetermined pressing position, the rib 214 of the developer container 201 comes into pressure contact with the sealing member 231. Furthermore, a space surrounded by the developer container 201 and the developer tray 230 is formed across the developer tray 230 in the longitudinal direction. In the first exemplary embodiment, by sending air generated by the fan 233 into the space surrounded by the developer container 201 and the developer tray 230 (a cooling space 232 for forming an airflow in the longitudinal direction of the developer tray 230), an airflow flowing in the longitudinal direction of the developer tray 230 is formed; accordingly, the developing unit 200 is cooled.

For example, when considering the temperature rise in the developing unit 200 in a case in which the image forming apparatus 100 is operated at a process speed of 70 ppm, it is preferable that the cross-sectional area of the cooling space 232 be larger than 450 mm² in order to efficiently cool the developing unit 200. Furthermore, for example, in a case in which the image forming apparatus 100 is operated at a process speed of 70 ppm, the cross-sectional area of the cooling space 232 is larger than 450 mm², and an axial fan, for example, is used as the fan 233, it is preferable that the velocity of the airflow formed in the cooling space 232 be larger than 2.5 m/sec.

A configuration of the cooling mechanisms of the developing units 200 will be described later with reference to FIGS. 11 and 12.

As illustrated in FIG. 10B, upon pivoting of the developing unit 200 about the rotation axis 212 to the predetermined separation position, the engagement between the rotation restriction rib 201C and the rotation restriction rib 230A is cancelled. In the above case, the developing unit 200 is pivoted about the rotation axis 212 to the predetermined separation position so that a predetermined clearance is obtained between the developing sleeve 202 and the photosensitive drum 221 inside the space (the cooling space 232) surrounded by the developer container 201 and the developer tray 230. The above can prevent scratches from being formed and peeling from occurring on the surfaces of the developing sleeve 202 and the photosensitive drum 221 owing to the developing unit 200 being unintendedly pivoted when inserting and removing the developing unit 200.

Furthermore, when the developing unit 200 is pivoted to the predetermined separation position, the sealing member 231 is separated from the rib 214 of the developer container 201. With the above, deterioration in the seal characteristic of the sealing member 231 caused by insertion and removal of the developing unit 200 can be prevented; accordingly, air can be prevented from leaking from the space (the cooling space 232) surrounded by the developer container 201 and the developer tray 230, and the decrease in the effect of cooling the developing unit 200 can be prevented from occurring.

In the first exemplary embodiment, during the operation of the image forming apparatus 100, each space (each cooling space 232) surrounded by the corresponding developer container 201 and the corresponding developer tray 230 is used as a space for cooling the corresponding developing unit 200. In particular, in the first exemplary embodiment, since the developer tray 230 is provided so as to oppose the bottom surfaces of the developer containers 201, the bottom surfaces of the developer containers 201 that are the largest areas that are in contact with the developer are cooled. Accordingly, in the first exemplary embodiment, the rise in temperature of the developer contained in the developing units 200 can be suppressed. Furthermore, in the first exemplary embodiment, during replacement of the developing units 200, each space (each cooling space 232) surrounded by the corresponding developer container 201 and the corresponding developer tray 230 is used as a space for separating the corresponding developing unit 200.

In conventional configurations, the developing units, which are detachable from the image forming apparatus in an independent manner with respect to the photoreceptor units, are cooled by attaching a duct for sending in the air from the fan. In such configurations, in addition to a space for moving the developing units in a direction in which the developing units are inserted into the image forming apparatus, a space for moving the duct in the above direction needs to be provided in advance inside the device. Furthermore, in the above configuration, in order to move the developing units to the contact positions, which is where the developing units are in contact with the photoreceptor units, a space in which the duct moves to the contact position needs to be provided in advance inside the device in addition to the space for the developing units to move to the contact positions. Furthermore, in a similar manner, in the above configuration, in order to move the developing units to the separation positions, which is where the developing units are separated from the photoreceptor units, a space in which the duct moves to the separation position needs to be provided in advance inside the device in addition to the space for the developing units to move to the separation positions.

On the other hand, if a space for separating the developing unit, which is detachable from the image forming apparatus in an independent manner with respect to the photoreceptor unit, from the photoreceptor unit, and a space for the flow of air from the fan cooling the developing units to pass are separately provided inside the device in advance, the size of the device becomes disadvantageously large.

Conversely, in the first exemplary embodiment, the separation of the developing units 200 can be performed in the spaces (the cooling spaces 232) surrounded by the developer containers 201 and the developer trays 230. Furthermore, in the first exemplary embodiment, the pressing positions and the separation positions of the developing units 200 can be provided inside the spaces (the cooling spaces 232) surrounded by the developer containers 201 and the developer trays 230. Accordingly, in the first exemplary embodiment, the space for separating the developing unit 200 does not have to be provided in addition to the space for cooling the developing unit 200.

In other words, when the position of the developing unit 200 with respect to the photoreceptor unit 220 is switched from the predetermined separation position to the predetermined pressing position, the developing unit 200 at the predetermined pressing position is brought to a state in which the cooling space 232 is formed with the guide unit 235.

For example, the temperature rise in the developing unit 200 in a case in which the image forming apparatus 100 is operated at a process speed of 70 ppm will be considered. In such a case, it is only sufficient that the developing unit 200 and the guide unit 235 are configured so that the cross-sectional area of the space surrounded by the developer container 201 and the developer tray 230 is larger than 450 mm² when the position of the developing unit 200 with respect to the photoreceptor unit 220 is switched from the predetermined separation position to the predetermined pressing position.

On the other hand, when the position of the developing unit 200 with respect to the photoreceptor unit 220 is switched from the predetermined pressing position to the predetermined separation position, the developing unit 200 at the predetermined separation position is brought to a state in which the developing unit 200 enters at least a portion of the cooling space 232.

Note that when the position of the developing unit 200 with respect to the photoreceptor unit 220 is switched between the predetermined pressing position and the predetermined separation position, the position of the guide unit 235 is fixed with respect to the main body of the image forming apparatus 100 such that the guide unit 235 does not move inside the image forming apparatus 100. As in the above manner, by sharing a portion of the space for the flow of air from the fan for cooling the developing unit pass with the space for separating the developing unit, which is detachable from the image forming apparatus in an independent manner with respect to the photoreceptor unit, from the photoreceptor unit, an increase in the size of the device can be avoided.

### Cooling Mechanism of Developing Unit

A configuration of the cooling mechanism of the developing unit 200 will be described next with reference to a perspective view in FIG. 11 and a cross-sectional view in FIG. 12. Each developing unit 200 is cooled by having the air from the fan 233 for cooling the developing units 200 flow into the corresponding space surrounded by the corresponding developer container 201 and the corresponding developer tray 230 (the corresponding cooling space 232 for forming the airflow in the longitudinal direction of the developer tray 230). For example, in a case in which the image forming apparatus 100 is operated at a process speed of 70 ppm, the cross-sectional area of the cooling space 232 is larger than 450 mm², and an axial fan, for example, is used as the fan 233, the fan 233 may be operated so that the velocity of the airflow formed in the cooling space 232 is larger than 2.5 m/sec. The air sent out with the fan 233 flows in an H-direction in FIG. 11 and in an I-direction in FIG. 11.

The air sent inside in the I-direction (the front side of the image forming apparatus 100) in FIG. 12 with the fan 233 passes through the opening 105 provided in the small cover 103, and reaches the bottom surface of the developer container 201 through an air path 234. Subsequently, the direction of the air that has reached the bottom surface of the developer container 201 is changed to a J-direction in FIG. 12 and the air flows into the space (the cooling space 232) formed between the bottom surface of the developer container 201 and the developer tray 230; accordingly, an airflow flowing in the longitudinal direction of the developer tray 230 is formed. Subsequently, the air that has passed through the cooling space 232 passes through the opening in the frame of the image forming apparatus 100 and is discharged to the rear surface of the image forming apparatus 100.

As described above, in the first exemplary embodiment, an airflow is formed along the bottom surface of each developer container 201, and with the air flowing in the J-direction in FIG. 12, the bottom surface of each developer container 201 is cooled. Since the bottom surface of each developer container 201 is the largest area in contact with the developer, the developer can be cooled in an efficient manner. Note that in the first exemplary embodiment, an example in which the guide unit 235 that guides the developing unit 200 in the direction in which the developing unit 200 is inserted in the image forming apparatus 100 is provided along the bottom surface of the developing unit 200 has been given. Furthermore, a configuration in which airflows that oppose at least the bottom surface of the developing units 200 are formed by providing the guide units 235 along the bottom surfaces of the developing units 200 such that the bottom surfaces of each developing units 200 are cooled have been described; however, the configuration is not limited to the above. The configuration may be modified such that the airflows that oppose at least the lateral surfaces of the developing units 200 are formed by providing the guide units 235 along the lateral sides of the developing units 200 such that the lateral sides of the developing units 200 are cooled. Furthermore, the configuration may be modified such that the airflows that oppose at least the upper surfaces of the developing units 200 are formed by providing the guide units 235 along the upper sides of the developing units 200 such that the upper sides of the developing units 200 are cooled.

In the first exemplary embodiment, when detaching the developing unit 200 from the main body of the image forming apparatus 100, the developing unit 200 is moved to the predetermined separation position so that the developing unit 200 and the photoreceptor unit 220 do not slide against each other. As illustrated in FIG. 7, the developing unit 200 is pivoted about the rotation axis 212 that is parallel to the developing sleeve 202 when the developing unit 200 is moved to the predetermined separation position. The position of the rotation axis 212 is determined by the main body of the image forming apparatus 100 and the front cover 213. Furthermore, the position of the front cover 213 is determined by the positioning pins 213A and 213B. With the above, the developing unit 200 is set to a position rotatable about the rotation axis 212.

Furthermore, in the first exemplary embodiment, an example has been described in which the position of the guide unit 235 is fixed with respect to the main body so that the guide unit 235 does not move at least when the position of the developing unit 200 with respect to the photoreceptor unit 220 is switched to the separation position from the contact position. It is only sufficient that the developing unit 200 is guided in the direction in which the developing unit 200 is inserted in the image forming apparatus 100 and that the developing unit 200 is pivotal about the rotation axis 212. Accordingly, the position of the guide unit 235 with respect to the main body of the image forming apparatus 100 does not have to be fixed except for when the position of the developing unit 200 with respect to the photoreceptor unit 220 is switched to the separation position from the contact position. For example, the guide unit 235 may be configured so that, in order to mount the developing unit 200 in the main body of the image forming apparatus 100, the guide unit 235 is capable of being moved in the unmounting direction of the developing unit 200 and is capable of being drawn out to the outside of the image forming apparatus 100.

In the case of such a configuration as above, the user first mounts the developing unit 200 on the guide unit 235 that has been drawn out to the outside of the image forming apparatus 100. Subsequently, the user inserts the guide unit 235 on which the developing unit 200 has been mounted into the image forming apparatus 100. Subsequently, after the position of the guide unit 235 inserted in the image forming apparatus 100 is set in the main body of the image forming apparatus 100, the developing unit 200 may be pivoted about the rotation axis 212.

### Second Exemplary Embodiment

A configuration in which the engagement between the rotation restriction rib 201C on the developer container 201 side and the rotation restriction rib 230A on the developer tray 230 side is cancelled by rotating the small cover 103 connected with the link shaft 103B in the anticlockwise direction about the rotating shaft 103A has been described in the first exemplary embodiment.

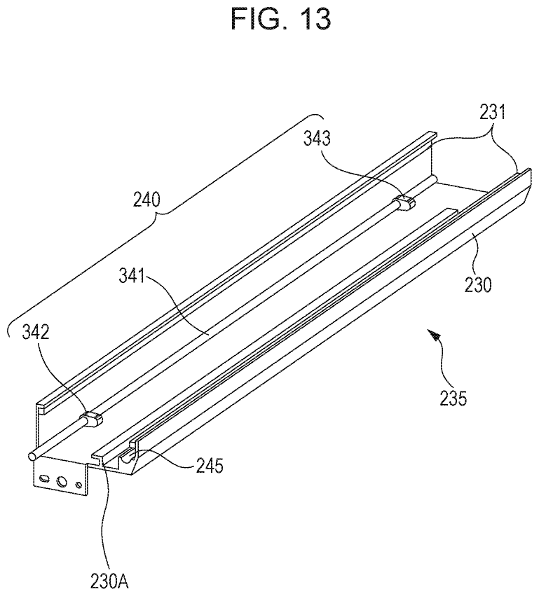

In a second exemplary embodiment, a configuration of the pressure unit 240 provided in the guide unit 235 and a configuration of the separating mechanism of the developing unit 200 are different from those of the first exemplary embodiment. Accordingly, the configuration of the guide unit 235 according to the second exemplary embodiment will be described with reference to the perspective view in FIG. 13.

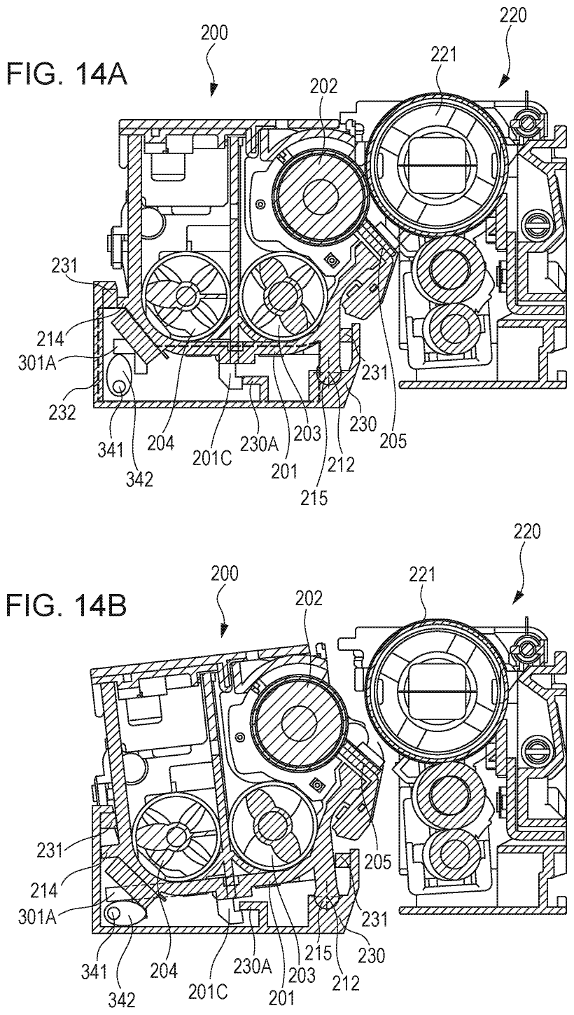

In the second exemplary embodiment, the engagement between the rotation restriction rib 201C on the developer container 201 side and the rotation restriction rib 230A on the developer tray 230 side is cancelled by operating a lever connected to the pressure unit 240. The configuration of the separating mechanism of the developing unit 200 according to the second exemplary embodiment will be described with reference to cross-sectional views in FIGS. 14A and 14B. Note that in the second exemplary embodiment, members that are the same as those of the first exemplary embodiment are attached with the same reference numerals, and description of the members that have the same configurations and functions as those of the first exemplary embodiment will be omitted. As illustrated in FIG. 13, in the second exemplary embodiment, the pressure unit 240 includes a pressure link 341 connected to the lever, and pressure members 342 and 343 disposed on the pressure link 341. Furthermore, as illustrated in FIGS. 14A and 14B, in the second exemplary embodiment, the developer container 201 is provided with an abutment portion 301A.

In the second exemplary embodiment, the operation of the lever rotates the pressure link 341 clockwise and, accordingly, the pressure members 342 and 343 rotate clockwise. Furthermore, each of the pressure members 342 and 343 that has rotated clockwise abut against the abutment portion 301A provided on the developer container 201. Furthermore, each of the pressure members 342 and 343 that has abutted against the abutment portion 301A applies pressure to the developing unit 200.

On the other hand, the operation of the lever rotating the pressure link 341 anticlockwise rotates each of the pressure members 342 and 343 clockwise. Furthermore, upon rotation of each of the pressure members 342 and 343 anticlockwise, each of the pressure members 342 and 343 become un-abutted against the abutment portion 301A and the pressure applied by the abutment portion 301A is relieved. With the above, the developing unit 200 is separated from the photoreceptor unit 220.

FIG. 14A illustrates the developing unit 200 that has been pivoted to the predetermined pressing position.

FIG. 14B illustrates the developing unit 200 that has been pivoted to the predetermined separation position.

As illustrated in FIG. 14A, upon pivoting of the developing unit 200 about the rotation axis 212 to the predetermined pressing position, the rotation restriction rib 201C on the developer container 201 side and the rotation restriction rib 230A on the developer tray 230 side become engaged with each other. Furthermore, upon pivoting of the developing unit 200 about the rotation axis 212 to the predetermined pressing position, the rib 214 and the wall surface of the developer container 201 come into pressure contact with the sealing member 231 such that the space (the cooling space 232 for forming the airflow in the longitudinal direction of the developer tray 230) is formed between the bottom surface of the developer container 201 and the developer tray 230.

In the second exemplary embodiment, similar to the first exemplary embodiment, by sending air generated by the fan 233 into the space (the cooling space 232) formed between the bottom surface of the developer container 201 and the developer tray 230, an airflow in the longitudinal direction of the developer tray 230 is formed; accordingly, the developing unit 200 is cooled. In the above, an airflow in the longitudinal direction of the guide unit 235 generated by the fan 233 is formed towards the back side of the image forming apparatus 100 from the front side of the image forming apparatus 100.

On the other hand, by rotating the pressure link 341 in the state in FIG. 14A anticlockwise, the pressure members 342 and 343 become separated from the abutment portion 301A. Furthermore, upon release of the pressing force of the pressure members 342 and 343, the developing unit 200 rotates about the rotation axis 212 and becomes separated from the photoreceptor unit 220. In so doing, the developing unit 200 is separated from the sealing member 231 provided in the developer tray 230. Furthermore, as illustrated in FIG. 14B, upon pivoting of the developing unit 200 about the rotation axis 212 to the predetermined separation position, the engagement between the rotation restriction rib 201C and the rotation restriction rib 230A is cancelled. In the above case, the developing unit 200 is pivoted about the rotation axis 212 to the predetermined separation position so that a predetermined clearance is obtained between the developing sleeve 202 and the photosensitive drum 221 inside the space (the cooling space 232 for forming the airflow in the longitudinal direction of the developer tray 230) formed between the bottom surface of the developer container 201 and the developer tray 230.

### Third Exemplary Embodiment

In a third exemplary embodiment, a configuration of the pressure unit 240 provided in the guide unit 235 and a configuration of the separating mechanism of the developing unit 200 are different from those of the first exemplary embodiment.

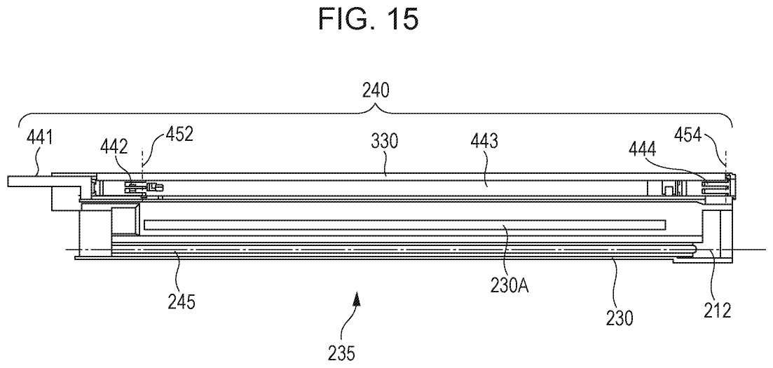

Accordingly, the configuration of the guide unit according to the third exemplary embodiment will be described with reference to the perspective view in FIG. 15. Note that in the third exemplary embodiment, members that are the same as those of the first exemplary embodiment are attached with the same reference numerals, and description of the members that have the same configurations and functions as those of the first exemplary embodiment will be omitted.

As illustrated in FIG. 15, the pressure unit 240 according to the third exemplary embodiment includes a pressure link 441 engaged with the small cover 103, a pressure stay 443 engaged with the pressure link 441, and pressure members 442 and 444 held by the pressure stay 443. The pressure member 442 is pivotal about a rotation axis 452. Furthermore, the pressure member 444 is pivotal about a rotation axis 454.

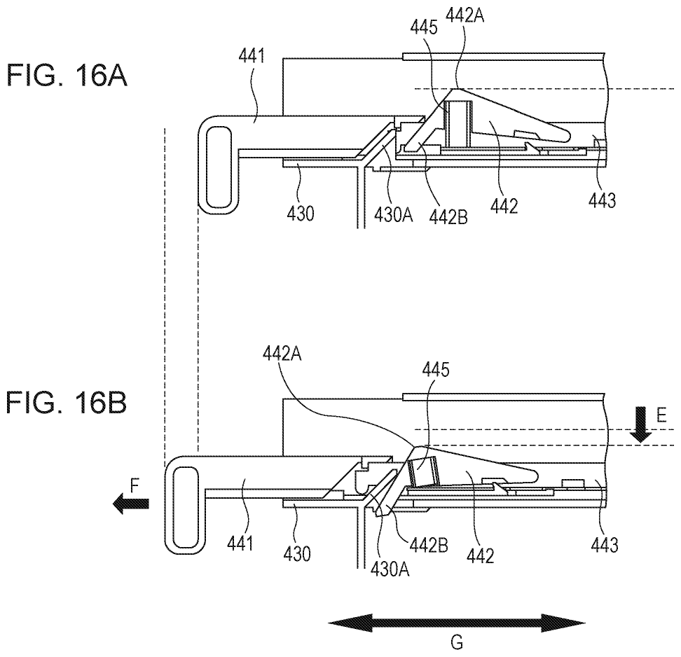

The configuration of the separating mechanism of the developing unit 200 according to the third exemplary embodiment will be described next with reference to cross-sectional views in FIGS. 16A and 16B. FIG. 16A illustrates a configuration of a pressing mechanism of the developing unit 200 according to the third exemplary embodiment. Meanwhile, FIG. 16B illustrates a configuration of a separating mechanism of the developing unit 200 according to the third exemplary embodiment.

The guide unit according to the third exemplary embodiment includes a rail 430 for sliding the pressure unit 240 in a G-direction in FIG. 16B. A pressure spring 445 is provided inside the pressure member 442. In a similar manner, a pressure spring 445 is provided inside the pressure member 444.

The pressure link 441, the pressure stay 443, the pressure members 442 and 444, and the pressure springs 445 are held by the rail 430. The pressure link 441, the pressure stay 443, the pressure members 442 and 444, and the pressure springs 445 can be slid in an integral manner with the pressure unit 240 along the rail 430. Upon pivoting of the pressure member 442 about the rotation axis 452, a pressure portion 442A of the pressure member 442 abuts against the pressure portion on the front side of the developer container 201. Furthermore, upon abutting of the pressure portion 442A against the pressure portion of the developer container 201, a pressure is applied to the developing unit 200 through the pressure spring 445.

In a similar manner, upon pivoting of the pressure member 444 about the rotation axis 454, a pressure portion of the pressure member 444 abuts against the pressure portion on the back side of the developer container 201. Furthermore, upon abutting of the pressure portion of the pressure member 444 against the pressure portion on the back side of the developer container 201, a pressure is applied to the developing unit 200 through the pressure spring 445. The small cover 103 is connected to the pivot link 244 connected to the pressure link 441 with the link shaft 103B. The small cover 103 is pivotal about the rotating shaft 103A. In a state illustrated in FIG. 16A (a state in which the pressure is applied to the developing unit 200 with the pressure spring 445), the small cover 103 is rotated anticlockwise about the rotating shaft 103A. Note that in the third exemplary embodiment, the link shaft 103B connected to the pressure link 441 is vertically above the rotating shaft 103A. Accordingly, upon turning of the link shaft 103B, the pressure link 441 engaged with the small cover 103 is moved in an F-direction in FIG. 16B.

With the above, as illustrated in FIG. 16B, the pressure link 441, the pressure stay 443, the pressure members 442 and 444, and the pressure springs 445 are slid along the rail 430 towards the front side of the image forming apparatus 100. As described above, by sliding the pressure unit 240 towards the front side of the image forming apparatus 100, an engagement portion 442B of the pressure member 442 and an engagement portion 430A of the rail 430 become engaged with each other.

In a similar manner, by sliding the pressure unit 240 towards the front side of the image forming apparatus 100, an engagement portion of the pressure member 444 and an engagement portion of the rail 430 become engaged with each other. In so doing, since the force that applies pressure to the developing unit 200 with the pressure springs 445 is relieved, the engagement between the pressure members 442 and 444 and the pressure portions of the developing unit 200 is canceled. Since the pressure members 442 and 444 are retreated in the above manner from the pressure portions of the developing unit 200, interference that may be caused when attaching and detaching the developing unit 200 from the main body of the image forming apparatus 100 can be avoided.

Furthermore, as illustrated in FIG. 16B, upon movement of the pressure stay 443 in the F-direction in FIG. 16B, the pressure member 442 rotates about the rotation axis 452 and the pressure member 442 moves in a direction (the E-direction in FIG. 16B) in which the pressure member 442 retreats from the pressure portion of the developing unit 200.

Furthermore, upon movement of the pressure member 442 in the E-direction in FIG. 16B, the developing unit 200 is pivoted about the rotation axis 212 in a direction in which the developing unit 200 retreats from the photoreceptor unit 220. The developing unit 200 is separated from the photoreceptor unit 220 in the above manner.

### Fourth Exemplary Embodiment

In the first, second, and third exemplary embodiments, examples have been described in which the developing unit 200 mounted in the image forming apparatus 100 is moved to the predetermined separation position from the predetermined pressing position, or to the predetermined pressing position from the predetermined separation position by pivoting the developing unit 200 about the rotation axis 212. In other words, the small cover 103 is rotated clockwise (in the circumferential direction) about the rotating shaft 103A of the small cover 103 while in a state in which the developing unit 200 is inserted inside the image forming apparatus 100 with the guide unit 235 and in which the developing unit 200 is in the predetermined separation position. With the above, the developing unit 200 mounted in the image forming apparatus 100 is pivoted about the rotation axis 212 from the predetermined separation position to the predetermined pressing position. Furthermore, the small cover 103 is rotated anticlockwise (in the circumferential direction) about the rotating shaft 103A of the small cover 103 while in a state in which the developing unit 200 is inserted inside the image forming apparatus 100 with the guide unit 235 and in which the developing unit 200 is in the predetermined pressing position. With the above, the developing unit 200 mounted in the image forming apparatus 100 is pivoted about the rotation axis 212 from the predetermined pressing position to the predetermined separation position.

On the other hand, in the fourth exemplary embodiment, the developing unit 200 mounted in the image forming apparatus 100 moves in a sliding manner from the predetermined separation position to the predetermined pressing position, or from the predetermined pressing position to the predetermined separation position. Hereinafter, an example of the above will be described. The small cover 103 is rotated clockwise (in the circumferential direction) about the rotating shaft 103A of the small cover 103 while in a state in which the developing unit 200 is inserted inside the image forming apparatus 100 with the guide unit 235 and in which the developing unit 200 is in the predetermined separation position. With the above, the developing unit 200 mounted in the image forming apparatus 100 is slid vertically upwards and the position of the developing unit 200 mounted in the image forming apparatus 100 with respect to the photoreceptor unit 220 is switched from the predetermined separation position to the predetermined pressing position.

Furthermore, the small cover 103 is rotated anticlockwise (in the circumferential direction) about the rotating shaft 103A of the small cover 103 while in a state in which the developing unit 200 is inserted inside the image forming apparatus 100 with the guide unit 235 and in which the developing unit 200 is in the predetermined pressing position. With the above, the developing unit 200 mounted in the image forming apparatus 100 is slid vertically downwards and the position of the developing unit 200 mounted in the image forming apparatus 100 with respect to the photoreceptor unit 220 is switched from the predetermined pressing position to the predetermined separation position.

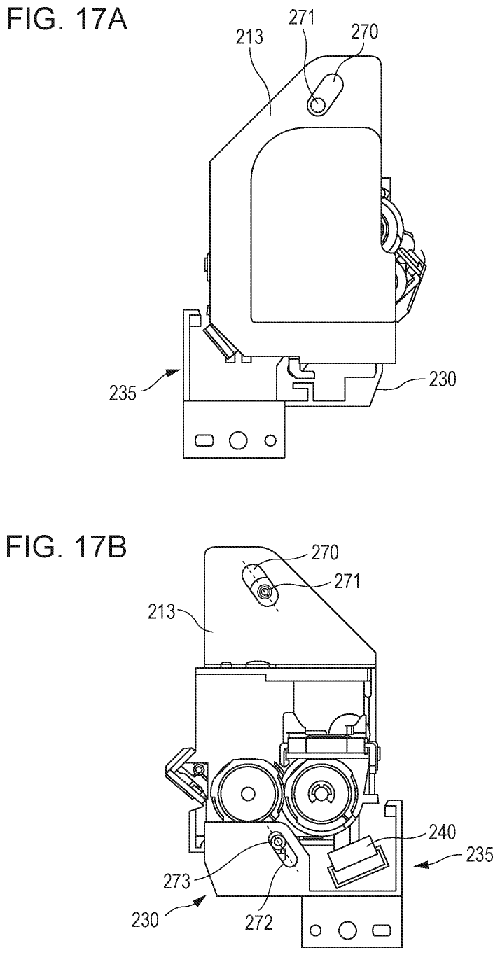

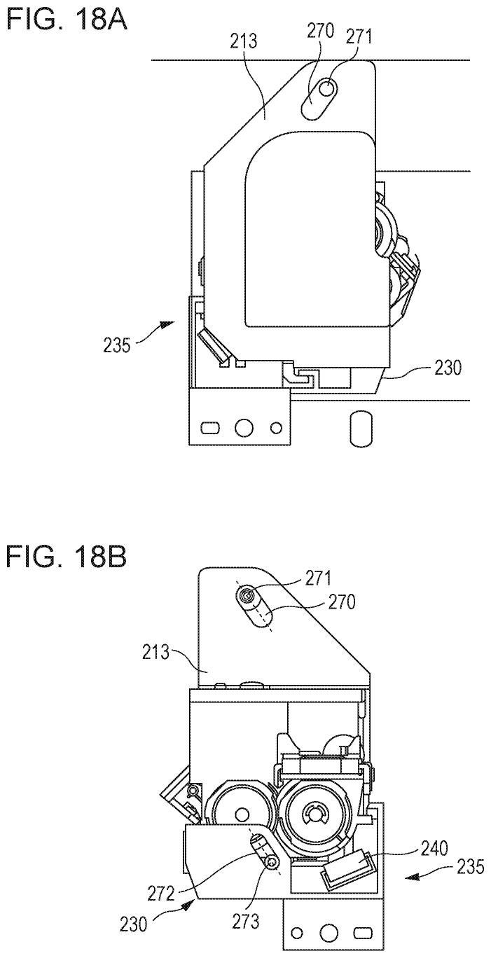

The configuration of the pressing mechanism and that of the separating mechanism of the developing units 200 according to the fourth exemplary embodiment will be described with reference to cross-sectional views in FIGS. 17A, 17B, 18A, and 18B. Note that in the fourth exemplary embodiment, members that are the same as those of the first exemplary embodiment are attached with the same reference numerals, and description of the members that have the same configurations and functions as those of the first exemplary embodiment will be omitted.

FIG. 17A is a cross-sectional view of the developing unit 200 viewed from the front side of the image forming apparatus 100 while in a state in which the developing unit 200 is inserted in the image forming apparatus 100 with the guide unit 235 and in which the developing unit 200 is at the predetermined pressing position. Furthermore, FIG. 17B is a cross-sectional view of the developing unit 200 viewed from the back side of the image forming apparatus 100 while in a state in which the developing unit 200 is inserted in the image forming apparatus 100 with the guide unit 235 and in which the developing unit 200 is at the predetermined pressing position.

FIG. 18A is a cross-sectional view of the developing unit 200 viewed from the front side of the image forming apparatus 100 while in a state in which the developing unit 200 is inserted in the image forming apparatus 100 with the guide unit 235 and in which the developing unit 200 is at the predetermined separation position. Furthermore, FIG. 18B is a cross-sectional view of the developing unit 200 viewed from the back side of the image forming apparatus 100 while in a state in which the developing unit 200 is inserted in the image forming apparatus 100 with the guide unit 235 and in which the developing unit 200 is at the predetermined separation position.

Similar to the first exemplary embodiment, as illustrated in FIG. 9A, in the fourth exemplary embodiment, the link shaft 103B of the small cover 103 is disposed vertically below the rotating shaft 103A of the small cover 103.

On the other hand, different from the first exemplary embodiment, in the fourth exemplary embodiment, as illustrated in FIGS. 17A, 17B, 18A, and 18B, a guide groove 270 is included in the front cover 213, and a guide groove 272 is included in the developer tray 230. In a state in which the developing unit 200 is inserted in the image forming apparatus 100 with the guide unit 235, a stepped screw 271 that determines a thrust direction of the developing unit 200 corresponds to the guide groove 270 of the front cover 213. Furthermore, the positioning boss 273 provided in the developer container 201 corresponds to the guide groove 272 of the developer tray 230. In the state in which the developing unit 200 is inserted in the image forming apparatus 100 with the guide unit 235, the stepped screw 271 and the positioning boss 273 are not disposed on the same coaxial line and are disposed at shifted positions where the center of gravity of the developing unit 200 is positioned therebetween.

The configuration of the pressing mechanism of the developing unit 200 according to the fourth exemplary embodiment will be described first with reference to FIGS. 17A and 17B.

When the small cover 103 is rotated clockwise about the rotating shaft 103A of the small cover 103 while the developing unit 200 is in a state in which the developing unit 200 is inserted inside the image forming apparatus 100 with the guide unit 235 and is at the predetermined separation position, the link shaft 103B is turned. Furthermore, upon turning of the link shaft 103B, the pressure link 241 is drawn outwards in a direction opposite the F-direction in FIG. 9B with the pivot link 244 in between. When the pressure link 241 is drawn out in a direction opposite the F-direction in FIG. 9B, the pressure surface of the pressure member 242 provided in the pressure unit 240 and a pressure surface F (the pressure portion 201A) on the front side of the developing unit 200 become abutted to each other. In a similar manner, the pressure surface of the pressure member 243 provided in the pressure unit 240 and a pressure surface R (the pressure portion) on the back side of the developing unit 200 become abutted to each other. With the above, pressure is applied to the pressure surfaces F and R of the developing unit 200 by the pressure members 242 and 243 such that the developing unit 200 is lifted along the pressure surfaces F and R.

While the developing unit 200 is inserted in the image forming apparatus 100 with the guide unit 235 and is at the predetermined separation position, the developing unit 200 is moved in a sliding manner vertically upwards in the above manner. Note that the angle to a horizontal plane when the developing unit 200 in the predetermined separation position moves vertically upwards in a sliding manner is 45 degrees or larger and 90 degrees or smaller.

Furthermore, when the developing unit 200 in the predetermined separation position moves vertically upwards in a sliding manner, the position of the developing unit 200 with respect to the photoreceptor unit 220 is switched to the predetermined pressing position from the predetermined separation position. In the above, the developing unit 200 is guided obliquely upwards along the guide groove 270 of the front cover 213 and the guide groove 272 of the developer tray 230 such that the developing unit 200 draws an obliquely upwards trajectory.

Furthermore, when the developing unit 200 moving obliquely upwards reaches the predetermined pressing position, the positioning boss 273 and the guide groove 272 of the developer tray 230 become engaged with each other and the stepped screw 271 and the guide groove 270 of the front cover 213 become engaged with each other.

When the developing unit 200 moving obliquely upwards reaches the predetermined pressing position, the bearings 206 each provided at the two end portions of the developing sleeves 202, and the abutment portions (for example, the bearings of the photoreceptor unit 220) each provided at the two end portions of the photoreceptor unit 220 abut against each other. Furthermore, the abutment portion on the front side of the developer container 201 and the abutment portion provided on the front side in the image forming apparatus 100 abut against each other, and, the abutment portion on the back side of the developer container 201 and the abutment portion provided on the back side in the image forming apparatus 100 abut against each other. As described above, by having the developing unit 200 and the photoreceptor unit 220 abut against each other at two points, and, the developing unit 200 and the inside of the image forming apparatus 100 abut against each other at two points, the position of the developing unit 200 with respect to the image forming apparatus 100 is determined. In the above, the cooling space 232 for forming the airflow that extends in the longitudinal direction of the developer tray 230 is formed between the bottom surface of the developer container 201 and the developer tray 230.

Furthermore, by sending air generated by the fan 233 into the space (the cooling space 232) formed between the bottom surface of the developer container 201 and the developer tray 230, an airflow in the longitudinal direction of the developer tray 230 is formed; accordingly, the developing unit 200 is cooled. In the above, an airflow in the longitudinal direction of the guide unit 235 generated by the fan 233 is formed towards the back side of the image forming apparatus 100 from the front side of the image forming apparatus 100.

The configuration of the separating mechanism of the developing unit 200 according to the fourth exemplary embodiment will be described next with reference to FIGS. 18A and 18B.

When the small cover 103 is rotated anticlockwise about the rotating shaft 103A of the small cover 103 while the developing unit 200 is in a state in which the developing unit 200 is inserted inside the image forming apparatus 100 with the guide unit 235 and is at the predetermined pressing position, the link shaft 103B is turned. Furthermore, upon turning of the link shaft 103B, the pressure link 241 is pushed inwards in the F-direction in FIG. 9B with the pivot link 244 in between.

When the pressure link 241 is pushed inside in the F-direction in FIG. 9B, the pressure surface of the pressure member 242 provided in the pressure unit 240 and the pressure surface F on the front side of the developing unit 200 (the pressure portion 201A) become un-abutted against each other. In a similar manner, the pressure surface of the pressure member 243 provided in the pressure unit 240 and the pressure surface R (the pressure portion) on the back side of the developing unit 200 become un-abutted against each other. With the above, the application of pressure to the pressure surfaces F and R of the developing unit 200 with the pressure members 242 and 243 is relieved.

While the developing unit 200 is inserted in the image forming apparatus 100 with the guide unit 235 and is at the predetermined pressing position, the developing unit 200 is moved in a sliding manner vertically downwards in the above manner. Note that the angle to a horizontal plane when the developing unit 200 in the predetermined pressing position moves vertically downwards in a sliding manner is 45 degrees or larger and 90 degrees or smaller.

Furthermore, when the developing unit 200 in the predetermined pressing position moves vertically downwards in a sliding manner, the position of the developing unit 200 with respect to the photoreceptor unit 220 is switched to the predetermined separation position from the predetermined pressing position. In the above, the developing unit 200 is guided obliquely downwards along the guide groove 270 of the front cover 213 and the guide groove 272 of the developer tray 230 such that the developing unit 200 draws an obliquely downwards trajectory.

Furthermore, when the developing unit 200 moving obliquely downwards reaches the predetermined separation position, the positioning boss 273 and the guide groove 272 of the developer tray 230 become un-engaged with each other. Furthermore, in the above, the developing unit 200 at the predetermined separation position is brought to a state in which the developing unit enters at least a portion of the area of the cooling space 232.

Note that when the position of the developing unit 200 with respect to the photoreceptor unit 220 is switched between the predetermined pressing position and the predetermined separation position, the position of the guide unit 235 is fixed with respect to the main body of the image forming apparatus 100 such that the guide unit 235 does not move inside the image forming apparatus 100.

As in the above manner, by sharing a portion of the space for the flow of air from the fan for cooling the developing unit pass with the space for separating the developing unit, which is detachable from the image forming apparatus in an independent manner with respect to the photoreceptor unit, from the photoreceptor unit, an increase in the size of the device can be avoided.

As described above, in the fourth exemplary embodiment, the pressing mechanism and the separating mechanism of the developing unit 200 have the above described characteristical configurations. With the above, the developing unit 200 mounted in the image forming apparatus 100 can be slid vertically upwards and the position of the developing unit 200 mounted in the image forming apparatus 100 with respect to the photoreceptor unit 220 can switched from the predetermined separation position to the predetermined pressing position. Furthermore, the developing unit 200 mounted in the image forming apparatus 100 can be slid vertically downwards and the position of the developing unit 200 mounted in the image forming apparatus 100 with respect to the photoreceptor unit 220 can switched from the predetermined pressing position to the predetermined separation position.

### Other Exemplary Embodiments

The present disclosure is not limited to the exemplary embodiments described above and various modifications (including organic combinations of the embodiments) based on the spirit of the disclosure can be made. The modifications are not excluded from the scope of the disclosure.

While in the exemplary embodiments described above, configurations have been described in which the developing units 200 and the photoreceptor units 220 are detachable in an independent manner with respect to the inside of the image forming apparatus 100, the disclosure is not limited to the above configurations. A modification may be made such that while the developing units 200 are configured so as to be detachable from the image forming apparatus 100 so that the developing units 200 can be replaced according to the life of the developing units 200, the photoreceptor units 220 are configured so as to be fixed inside the image forming apparatus 100 in an undetachable manner.

Furthermore, in the exemplary embodiments described above, examples have been described in which the photoreceptor units 220 include, other than the photosensitive drums 221 (221a to 221d), charging rollers that charge the photosensitive drums 221 (221a to 221d); however, the disclosure is not limited to the above examples. A modification may be made such that the photoreceptor units 220 do not include the charging rollers and are configured only of the photosensitive drums 221 (221a to 221d).

Furthermore, examples have been described in the exemplary embodiments described above in which the intermediate transfer belt 260 is used as an image carrier. However, not limited to the above examples, an image forming apparatus 100 configured to perform transferring by having a recording medium S come into direct contact with the photosensitive drums 221 (221a and 221d) in a sequential manner may be used in the disclosure. In such a case, the photosensitive drums 221 (221a to 221d) constitute rotatable image carriers that carry the toner images.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. An image forming apparatus comprising:
an image carrier unit including an image carrier;
a developing unit including a developer carrying member configured to carry developer containing toner and carriers for developing an electrostatic latent image formed on the image carrier and being detachable from the image forming apparatus;
a pressing mechanism configured to press the developing unit in a state that the developing unit is attached to the image forming apparatus;
a guide mechanism configured to guide the developing unit so that the developing unit is moved from a first position toward a second position along with pressing the developing unit by the pressing mechanism being performed in the state that the developing unit is attached to the image forming apparatus, and to guide the developing unit so that the developing unit is moved from the second position toward the first position along with pressing the developing unit by the pressing mechanism being released in the state that the developing unit is attached to the image forming apparatus,
wherein the developer carrying member is positioned at a developing position where an electrostatic latent image formed on the image carrier is developed in a state that the developing unit is positioned at the second position, and the developer carrying member is positioned at a separation position separated from the developing position in a state that the developing unit is positioned at the first position,
wherein a shortest distance between the developer carrying member and the image carrier in the state that the developer carrying member is positioned at the developing position is shorter than a shortest distance between the developer carrying member and the image carrier in the state that the developer carrying member is positioned at the separation position, and
wherein the guide mechanism is provided with a guide groove so that a moving trajectory of the developing unit when the developing unit is moved along the guide groove from the first position toward the second position is 45 degrees or larger and 90 degrees or smaller with respect to a horizontal plane, and a moving trajectory of the developing unit when the developing unit is moved along the guide groove from the second position toward the first position is 45 degrees or larger and 90 degrees or smaller with respect to the horizontal plane.

2. The image forming apparatus according to claim 1,
wherein the developing unit is provided with a boss to be engaged with the guide groove, and
wherein the guide mechanism guides the developing unit so that the developing unit is moved from the first position toward the second position in a state that the boss is engaged with the guide groove, and guides the developing unit so that the developing unit is moved from the second position toward the first position in a state that the boss is engaged with the guide groove.

3. The image forming apparatus according to claim 1, further comprising:
an open-close member being openable and closable in the state that the developing unit is attached to the image forming apparatus; and
a link member connected to the open-close member and movable in an attachment direction in which the developing unit is to be attached to the image forming apparatus and a detachment direction in which the developing unit is to be detached from the image forming apparatus,
wherein, in the state that the developing unit is positioned at the second position, the link member is moved in the attachment direction along with the open-close member being opened and pressing the developing unit by the pressing mechanism is released along with the link member being moved in the attachment direction, and
wherein, in the state that the developing unit is positioned at the first position, the link member is moved in the detachment direction along with the open-close member being closed and pressing the developing unit by the pressing mechanism is performed along with the link member being moved in the detachment direction.
